(19) United States
(12) Patent Application Publication
(10) Pub. No.: US 2021/0033415 A1
(43) Pub. Date: Feb. 4, 2021

(54) VEHICLE ROUTE CONTROL

(71) Applicant: Ford Global Technologies, LLC, Dearborn, MI (US)

(72) Inventor: Emad ZAHEDI, Okemos, MI (US)

(21) Appl. No.: 16/767,227

(22) PCT Filed: Nov. 29, 2017
(86) PCT No.: PCT/US2017/063610

§ 371 Date: May 27, 2020

(51) Int. Cl. G01C 21/34; G01C 21/36

(52) U.S. Cl. CPC G01C 21/3492; G01C 21/3691

(57) ABSTRACT

A system includes a computer including a processor and a memory. The memory includes instructions executable by the processor to determine a route density that is a measure of an amount of cargo traveling between specified locations and destinations per unit of distance traveled, to determine a route for each of a plurality of vehicles based on a maximum route density, and to instruct a plurality of computers to actuate components of the plurality of vehicles to move along the routes.

### BACKGROUND

Vehicles travel along predetermined routes to transport cargo independently of other vehicles that can transport cargo. The cargo may have pickup locations and destinations that may not align with the predetermined routes. Systems are lacking for communicating between the cargo and vehicles and determining routes for vehicles to transport cargo according to the specific pickup locations and destinations of the cargo.

### BRIEF DESCRIPTION OF THE DRAWINGS

FIG. 1 is a block diagram of an example system for moving cargo.

FIG. 2 illustrates example vehicles moving the cargo along routes.

FIG. 3 illustrates an example process for moving the cargo.

### DETAILED DESCRIPTION

A system includes a computer including a processor and a memory, the memory including instructions executable by the processor to determine a route density that is a measure of a number of items of cargo traveling between specified locations and destinations per unit of distance traveled, determine a route for each of a plurality of vehicles based on a maximum route density, and instruct a plurality of computers to actuate components of the plurality of vehicles to move along the routes.

The instructions can further include instructions to determine the maximum route density based on a combined set of the locations and destinations of specified items of cargo.

The instructions can further include instructions to determine a first cluster including a first location and a first destination of a first item of cargo, to determine a second cluster including a second location and a second destination of a second item of cargo, and to determine at least one route to maximize a route density for a joined cluster combining the first and second clusters.

The instructions can further include instructions to determine the route based on a distance between one of the locations and destinations and another of the locations and destinations.

The instructions can further include instructions to determine a route density for each pair of one location and one destination, and to determine a maximum route density from the determined route densities.

The route can include a sequential list of stops, each stop being one of the locations and destinations, and wherein the instructions can further include instructions to determine the route to minimize the distance between consecutive stops.

The instructions can further include instructions to identify a starting point for one of the routes, to identify the vehicle having a location closest to the starting point, and to instruct the computer of the identified vehicle to actuate a component of the identified vehicle to move the identified vehicle to the starting point.

The instructions can further include instructions to determine a vehicle cargo capacity and, upon determining that the number of items of cargo for one of the routes exceeds the vehicle cargo capacity, actuate a component in a second vehicle to move the second vehicle along the route.

A system includes a vehicle including vehicle components, means for determining a route density that is a measure of a number of items of cargo traveling between specified locations and destinations per unit of distance traveled, means for determining a route for the vehicle based on a maximum route density, and means for actuating the vehicle components to move the vehicle along the route.

The system can further include means for determining the route density based on a combined set of the locations and destinations of specified items of cargo.

The system can further include means for determining the route based on a distance between one of the locations and destinations and another of the locations and destinations.

The system can further include means for determining a route density for each pair of one location and one destination, and to determine a maximum route density from the determined route densities.

A method includes determining a route density that is a measure of a number of items of cargo traveling between specified locations and destinations per unit of distance traveled, determining a route for each of a plurality of vehicles based on a maximum route density, and instructing a plurality of vehicle computers to actuate components of the plurality of vehicles to move the vehicles along the respective routes.

The method can further include determining the route density based on a combined set of the locations and destinations of specified items of cargo.

The method can further include determining a first cluster including a first item of cargo having a first location and a first destination, determining a second cluster including a second item of cargo having a second location and a second destination, and determining at least one route to maximize a route density for a joined cluster combining the first and second clusters.

The method can further include determining the route based on a distance between one of the locations and destinations and another of the locations and destinations.

The method can further include determining a route density for each pair of one location and one destination, and to determine a maximum route density from the determined route densities.

The route can include a sequential list of stops, each stop being one of the locations and destinations, and wherein the method can further include determining the route to minimize the distance between consecutive stops.

The method can further include identifying a starting point for one of the routes, identifying the vehicle having a location closest to the starting point, and instructing the computer of the identified vehicle to actuate a component of the identified vehicle to move the identified vehicle to the starting point.

The method can further include determining a vehicle cargo capacity and, upon determining that the number of items of cargo for one of the routes exceeds the vehicle cargo capacity, actuating a component in a second vehicle to move the second vehicle along the route.

Controlling vehicles to travel specified routes, e.g., for moving cargo can reduce a total distance traveled by the vehicles transporting the cargo while increasing the number of items of cargo transported. The routes can be determined using clusters of pickup locations and destinations of the cargo and joining clusters to reduce the distance traveled by the vehicles. Furthermore, the vehicles can follow routes closest to the current locations of the vehicles, reducing travel distance for the vehicles. Thus, the number of items of cargo moved per unit of distance traveled by the vehicles can be increased.

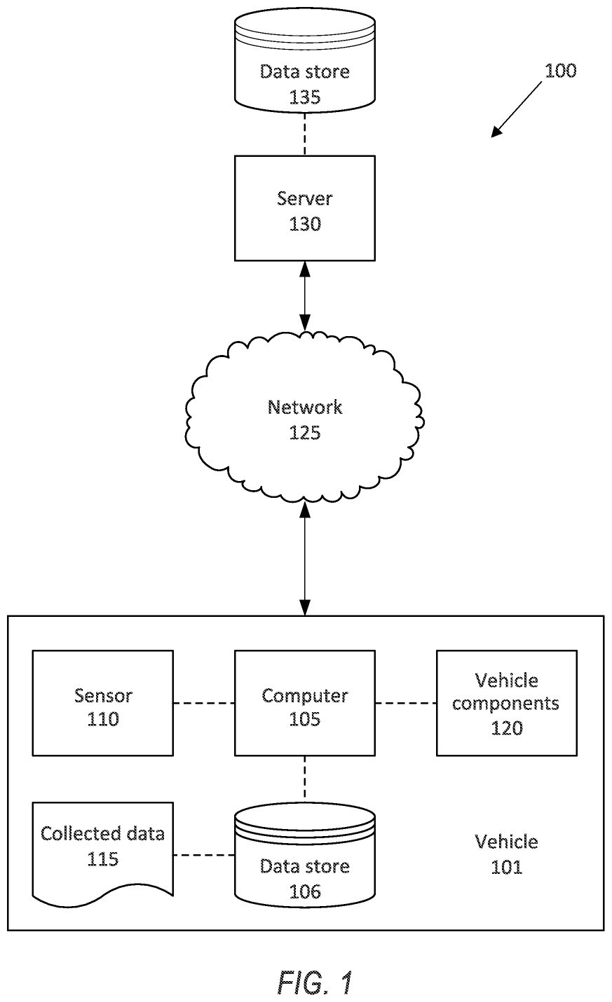

FIG. 1 illustrates an example system 100 for moving cargo with a vehicle 101. A computer 105 in the vehicle 101 is programmed to receive collected data 115 from one or more sensors 110. For example, vehicle 101 data 115 may include a location of the vehicle 101, data about an environment around a vehicle, data about an object outside the vehicle such as another vehicle, etc. A vehicle 101 location is typically provided in a conventional form, e.g., geo-coordinates such as latitude and longitude coordinates obtained via a navigation system that uses the Global Positioning System (GPS). Further examples of data 115 can include measurements of vehicle 101 systems and components, e.g., a vehicle 101 velocity, a vehicle 101 trajectory, etc.

The computer 105 is generally programmed for communications on a vehicle 101 network, e.g., including a communications bus, as is known. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, sensors, etc., including sensors 110. Alternatively or additionally, in cases where the computer 105 actually comprises multiple devices, the vehicle network may be used for communications between devices represented as the computer 105 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The data store 106 may be of any known type, e.g., hard disk drives, solid state drives, servers, or any volatile or non-volatile media. The data store 106 may store the collected data 115 sent from the sensors 110.

Sensors 110 may include a variety of devices. For example, as is known, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc. The sensors 110 could also include short range radar, long range radar, LIDAR, and/or ultrasonic transducers.

Collected data 115 may include a variety of data collected in a vehicle 101. Examples of collected data 115 are provided above, and moreover, data 115 are generally collected using one or more sensors 110, and may additionally include data calculated therefrom in the computer 105, and/or at the server 130. In general, collected data 115 may include any data that may be gathered by the sensors 110 and/or computed from such data.

The vehicle 101 may include a plurality of vehicle components 120. As used herein, each vehicle component 120 includes one or more hardware components adapted to perform a mechanical function or operation—such as moving the vehicle, slowing or stopping the vehicle, steering the vehicle, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, and the like.

When the computer 105 operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computer 105. A semi-autonomous mode is one in which at least one of vehicle 101 propulsion (typically via a powertrain including an electric motor and/or internal combustion engine), braking, and steering are controlled at least partly by the computer 105 as opposed to a human operator. In a non-autonomous mode, i.e., a manual mode, the vehicle 101 propulsion, braking, and steering are controlled by the human operator.

The system 100 may further include a network 125 connected to a server 130 and a data store 135. The computer 105 may further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

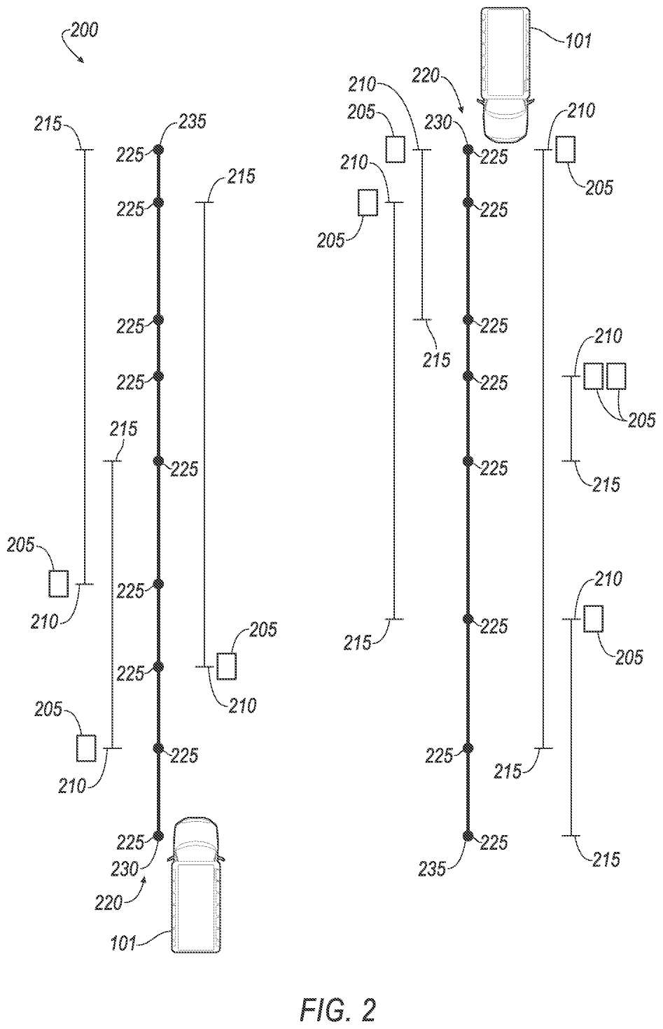

FIG. 2 illustrates an example cargo moving system 200 including vehicles 101 to move cargo 205. As used herein, the “cargo” 205 can include animate objects, i.e., passengers, and/or inanimate objects movable by the vehicles 101, e.g., packages, boxes, etc. The cargo 205 can include a communication device, e.g., a phone, a tablet, a laptop, a computer connected to the network 125, etc., to communicate with the server 130. For example, when the cargo 205 is a passenger, the passenger can use a phone to communicate over the network 125 with the server 130. In another example, when the cargo 205 is a package, the package can include a communicator, e.g., an RFID tag, that is programmed to communicate the pickup location 210 and the destination 215 over the network 125 with the server 130. Alternatively, the sender of the package can use a laptop, a tablet, etc., to send the pickup location 210 and the destination 215 of the package to the server 130. Yet alternatively, the package can be stored in an autonomously movable package carrier that includes a carrier computer in communication with the network 125 to send the pickup location 210 and the destination 215 to the server 130. The pickup location 210 and the destination 215 can be geo-coordinates identifying the current location of the item of cargo 205 and the intended destination of the item of cargo 205.

The server 130 can receive a plurality of pickup locations 210 and destinations 215 for a plurality of items of cargo 205. The server 130 can arrange the pickup locations 210 and destinations 215 into a plurality of clusters. As used herein, a “cluster” is a set of pickup locations 210 and destinations 215 in a specified order. The server 130 can determine the order of the pickup locations 210 and destinations 215 in the cluster to minimize the distance traveled by a vehicle 101 between the pickup locations 210 and the destinations 215. For example, a first cluster can include a first pickup location P₁ and a first destination D₁, represented as (P₁, D₁), and a second cluster can include a second pickup location P₂ and a second destination D₂, represented as (P₂, D₂). Starting at the first pickup location P₁, there are three possible orders to combine the first cluster and the second cluster into a joined cluster, i.e., a single cluster that includes all elements of two or more clusters:

P₁, P₂, D₁, D₂ (1)

P₁, P₂, D₂, D₁ (2)

P₁, D₁, P₂, D₂ (3)

The server 130 can join or merge the first cluster and the second cluster into a joined cluster that minimizes the total distance traveled between the elements of the joined cluster. That is, a specific order of the locations P₁, P₂, D₁, D₂ exists, as shown in of Equations (1), (2), and (3), that will have a shortest distance between each consecutive location. The server 130 can determine the order with the shortest distance, i.e., one of Equations (1), (2), and (3), and determine the joined cluster as that specific order. In general, the server 130 can determine the shortest total distance of a plurality of clusters (Pₖ, Dₖ) joined into a single joined cluster by determining the shortest distance between consecutive locations listed in the clusters (provided that Dₖ is after Pₖ, i.e., the destination 215 is after the pickup location 210 for an item of cargo 205). Thus, the total distance traveled by a vehicle 101 following the joined cluster is reduced. For example, if Equation 3 is the joined cluster, the server 130 can create another joined cluster with the cluster of Equation 3 and a third cluster (P₃, D₃) by comparing the pickup location P₃ to each location in the joined cluster to find the minimized distance between P₃ and one of the other locations, and then repeating for D₃. This order for the pickup locations 210 and the destinations 215 thus minimizes the total distance traveled when a vehicle 101 follows the cluster. The server 130 can compare pairwise distances, i.e., a distance between a pair of locations including a first location that is a pickup location 210 and/or destination 215 and a second location that is another pickup location and/or destination 215, between each pair of pickup locations 210 and/or destinations 215 to determine the order that minimizes the total distance of the joined cluster.

The server 130 can determine a route density for the joined cluster. The server 130 can determine a number of items of cargo 205 in a joined cluster. Each item of cargo 205 can send a single cluster over the network 125 to the server 130, and the server 130 can, upon joining a plurality of clusters, determine a total number of items of cargo 205 for the joined cluster. The server 130 can thus determine the route density for each joined cluster:

$$route density = \frac{number of items of cargo}{length of cluster} \qquad ( 4 )$$

A route density is a measure of a total number of items of cargo 205 in the cluster per unit of distance traveled by a vehicle 101 following the pickup locations 210 and the destinations 215 in the cluster. The server 130 can thus determine a joined cluster that maximizes the route density, i.e., moves the most cargo per unit distance. By ordering pickup locations 210 and destinations 215 in the joined cluster to reduce the distance between consecutive pickup locations 210 and/or destinations 215, the route density of the joined cluster increases and the vehicle 101 can transport more items of cargo 205 while reducing a distance traveled by the vehicles 101. The server 130 can determine a plurality of joined clusters from the clusters from the cargo 205, each joined cluster maximizing the route density, i.e., joining an additional cluster would not increase the route density of the newly joined cluster. Furthermore, the server 130 can determine the route density for each pair of points in the joined cluster, each pair being one pickup location 210 or destination 215, and another pickup location 210 or destination 215. The server 130 can determine the joined cluster based on the maximum route densities for each pair of pickup locations 210 and/or destinations 215.

One example of a technique for joining clusters is with a matrix of route densities. For a plurality n of clusters, the server 130 can generate a n×n matrix, each element of the matrix being the route density of a joined cluster consisting of the clusters corresponding to the indexes of the element. For example, in a 5×5 matrix M, the matrix M contains the route densities for joining of pairs of 5 clusters C₁, C₂, C₃, C₄, C₅, and an element M_{xy}, where x and y are integers from 1 to 5, is the route density of the joined cluster formed from the clusters Cₓ, C_{y}, e.g., the element M₂₃ is the route density of the joined cluster C₂₃ formed by joining the clusters C₂ and C₃.

The server 130 can determine the maximum element Mᵢⱼ in M. The maximum element Mᵢⱼ is the maximum value in the matrix M and represents the joined cluster with the highest route density, the joined cluster formed by joining the clusters Cᵢ and Cⱼ. Upon determining the maximum element Mᵢⱼ, the server 130 can reduce the size of matrix M, replacing the clusters Cᵢ, Cⱼ with the joined cluster Cᵢⱼ. The server 130 can assign values for the elements of M according to the following equations:

$$\begin{matrix}{M}_{ik , new} = {M}_{ik} + {M}_{jk} + {M}_{ij} - \frac{{M}_{kk}}{2} & ( 5 ) \\ {M}_{ki , new} = {M}_{ki} + {M}_{kj} + {M}_{ij} - \frac{{M}_{kk}}{2} & ( 6 )\end{matrix}$$

where k is an integer between 1 and n, M_{ik,new} is a new value for the element Mᵢₖ determined by Equation (5), and M_{ki,new} is a new value for the element Mₖᵢ determined by Equation (6). Thus, after applying Equations (5)-(6) for all k up to and including n, each element in M is updated to account for the joined cluster Cᵢⱼ. The server 130 can normalize the route densities of M for all s, t from 1 to n according to the following equation:

$${M}_{st} = \frac{{M}_{st}}{number of elements in cluster {C}_{st}} \qquad ( 7 )$$

Upon normalizing the route densities, the server 130 can remove the row and column associated with the index j, forming a n−1×n−1 matrix M′. The server 130 can continue to determine the maximum route density, join the clusters having the highest route density, and reduce the size of the route density matrix until the server 130 determines a 1×1 matrix, i.e., until one joined cluster remains.

The Equations (5)-(6) replace the cluster Cᵢ with the joined cluster Cᵢⱼ, which takes the index i. The server 130 can remove the row and column of the matrix M corresponding to the index j. That is, after applying Equations (5)-(6), the server 130 determines a matrix M′ that has n−1 clusters, one of which is the joined cluster Cᵢⱼ that is positioned at the index i. For example, if the maximum value of the 5×5 matrix M is M₂₃, corresponding to clusters C₂, C₃, the 4×4 matrix M′ for all elements M′₂ₖ (where k is a number between 1 and 4) includes the route densities for the joined cluster of the cluster C₂₃ and the cluster Cₖ.

The server 130 can determine a plurality of routes 220 based on the joined clusters. The routes 220 thus can increase the number of items of cargo 205 transported and reduce the total distance traveled to transport the cargo 205. Each route 220 includes a plurality of stops 225 corresponding to the pickup locations 210 and destinations 215 of cargo 205 associated with one of the joined clusters. Thus, as the vehicle 101 travels along the route 220, stopping at each of the stops 225, items of cargo 205 can join and leave the vehicle 101 from their respective pickup locations 210 to their respective destinations 215, such that when the vehicle 101 completes the route 220, all items of cargo 205 have reached their respective destinations 215. Because the server 130 determined the route 220 to maximize the route density of the joined cluster, the server 130 can determine the route 220 to minimize the distance between consecutive stops 225. That is, the server 130 can determine the route 220 to maximize the route density by minimizing the distance between consecutive stops 225. The route 220 can have a starting point 230 and an end point 235. In the example of FIG. 2, two example routes 220 are shown, and example items of cargo 205 with pickup locations 210 and destinations 215 are shown corresponding to stops 225 on the routes 220.

FIG. 2 illustrates two example routes 220. Each route 220 includes a plurality of stops 225, each stop 225 corresponding to a pickup location 210 and/or a destination 215 for at least one item of cargo 205. For clarity, not all cargo 205 corresponding to each stop 225, and the pickup locations 210 and destinations 215 represented by the stop 225, is shown. The vehicle 101 can collect cargo 205 at one of the stops 225 and transport the cargo 205 to another stop 225 until the vehicle 101 completes the route 220, i.e., reaches the end point 235.

The server 130 can assign at least one vehicle 101 to each route 220. The server 130 can identify locations of a plurality of vehicles 101, e.g., autonomous vehicles 101 in a fleet employed to transport items of cargo 205. The server 130 can compare the starting points 230 of the routes 220 to the locations of the vehicles 101. The server 130 can assign the vehicle 101 having a location closest to each starting point 230 to follow the route 220 associated with the starting point 230. As shown in FIG. 2, each route 220 has one vehicle 101 assigned.

The server 130 can determine a cargo capacity of each vehicle 101. The cargo capacity can be a maximum number of items of cargo 205 that a specific vehicle 101 can carry. The server 130 can compare the cargo capacity of a vehicle 101 assigned to a route 220 to the number of items of cargo 205 transported on the route 220. If at any point on the route 220 the number of items of cargo 205 to be transported by the vehicle 101 exceeds the cargo capacity of the vehicle 101, the server 130 can assign another vehicle 101 to the route 220.

The server 130 can instruct each computer 105 in each vehicle 101 to actuate one or more components 120 to move to a respective starting point 230 and to follow the route 220. For example, the server 130 can instruct the computer 105 to actuate a propulsion 120, a steering 120, and a brake 120 in each vehicle 101 to stop at each stop 225 along the route 220 to move the cargo 205 to the respective destinations 215.

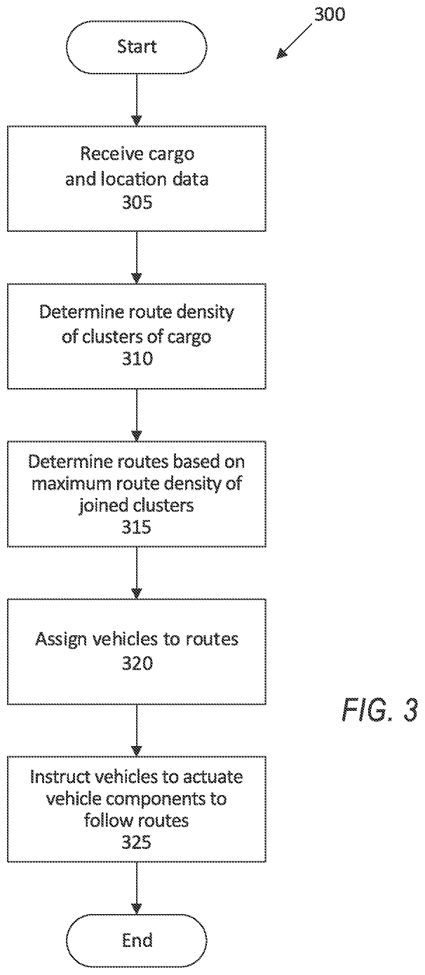

FIG. 3 illustrates an example process 300 for transporting items of cargo 205. The process 300 begins in a block 305, in which the server 130 receives pickup location 210 and destination 215 data 115 from a plurality of items of cargo 205. The data 115 can include geo-coordinates of the pickup location 210 of the item of cargo 205 and the destination 215 of the item of cargo 205.

Next, in a block 310, the server 130 determines a plurality of route densities for the items of cargo 205. As described above, the server 130 can compare the distance between the joined cluster a plurality of items of cargo 205 to the number of items of cargo 205 in the joined cluster transported to determine the route density for each joined cluster. The server 130 can join a plurality of clusters to increase the route density of the newly joined cluster.

Next, in a block 315, the server 130 determines a plurality of routes 220 based on the joined clusters. As described above, the server 130 can join a plurality of clusters determined from the items of cargo 205 to determine a plurality of joined clusters. The server 130 can join a plurality of clusters, each cluster corresponding to one or more items of cargo 205, until joining an additional cluster would not increase the route density of the current joined cluster. The server 130 can then determine the routes 220 based on the joined clusters, having maximized the route density for each joined cluster.

Next, in a block 320, the server 130 assigns one or more vehicles 101 to each route 220. Each route has a starting point 230 and an end point 235, and the server 130 can assign the vehicle 101 closest to each starting point 230 to collect cargo 205 along the route 220. The server 130 can determine a cargo capacity for each vehicle 101 and assign more than one vehicle 101 for a specific route 220 if the number of items of cargo 205 on the route 220 exceeds the cargo capacity of the vehicle 101 closest to the starting point 230.

Next, in a block 325, the server 130 instructs one or more computers 105 in one or more vehicles 101 to actuate one or more vehicle components 120 to move the one or more vehicles 101 along one or more routes 220. For example, the server 130 can instruct the computer 105 in one of the vehicles 101 to actuate a propulsion 120 to move the vehicle 101 from a stop 225 on the route 220 to another stop 225 on the route 220 and apply a brake 120 upon reaching one of the stops 225. Following the block 325, the process 300 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computers 105 generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computer 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 300, one or more of the steps could be omitted, or the steps could be executed in a different order than shown in FIG. 3. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer including a processor and a memory, the memory including instructions executable by the processor to:
determine a route density that is a measure of a number of items of cargo traveling between specified locations and destinations per unit of distance traveled;
determine a route for each of a plurality of vehicles based on a maximum route density; and
instruct a plurality of computers to actuate components of the plurality of vehicles to move along the routes.

2. The system of claim 1, wherein the instructions further include instructions to determine the maximum route density based on a combined set of the locations and destinations of specified items of cargo.

3. The system of claim 1, wherein the instructions further include instructions to determine a first cluster including a first location and a first destination of a first item of cargo, to determine a second cluster including a second location and a second destination of a second item of cargo, and to determine at least one route to maximize a route density for a joined cluster combining the first and second clusters.

4. The system of claim 1, wherein the instructions further include instructions to determine the route based on a distance between one of the locations and destinations and another of the locations and destinations.

5. The system of claim 1, wherein the instructions further include instructions to determine a route density for each pair of one location and one destination, and to determine a maximum route density from the determined route densities.

6. The system of claim 1, wherein the route includes a sequential list of stops, each stop being one of the locations and destinations, and wherein the instructions further include instructions to determine the route to minimize the distance between consecutive stops.

7. The system of claim 1, wherein the instructions further include instructions to identify a starting point for one of the routes, to identify the vehicle having a location closest to the starting point, and to instruct the computer of the identified vehicle to actuate a component of the identified vehicle to move the identified vehicle to the starting point.

8. The system of claim 1, wherein the instructions further include instructions to determine a vehicle cargo capacity and, upon determining that the number of items of cargo for one of the routes exceeds the vehicle cargo capacity, actuate a component in a second vehicle to move the second vehicle along the route.

9. A system, comprising:
a vehicle including vehicle components;
means for determining a route density that is a measure of a number of items of cargo traveling between specified locations and destinations per unit of distance traveled;
means for determining a route for the vehicle based on a maximum route density; and
means for actuating the vehicle components to move the vehicle along the route.

10. The system of claim 9, further comprising means for determining the route density based on a combined set of the locations and destinations of specified items of cargo.

11. The system of claim 9, further comprising means for determining the route based on a distance between one of the locations and destinations and another of the locations and destinations.

12. The system of claim 9, further comprising means for determining a route density for each pair of one location and one destination, and to determine a maximum route density from the determined route densities.

13. A method, comprising:
determining a route density that is a measure of a number of items of cargo traveling between specified locations and destinations per unit of distance traveled;
determining a route for each of a plurality of vehicles based on a maximum route density; and
instructing a plurality of vehicle computers to actuate components of the plurality of vehicles to move the vehicles along the respective routes.

14. The method of claim 13, further comprising determining the route density based on a combined set of the locations and destinations of specified items of cargo.

15. The method of claim 14, further comprising determining a first cluster including a first item of cargo having a first location and a first destination, determining a second cluster including a second item of cargo having a second location and a second destination, and determining at least one route to maximize a route density for a joined cluster combining the first and second clusters.

16. The method of claim 13, further comprising determining the route based on a distance between one of the locations and destinations and another of the locations and destinations.

17. The method of claim 13, further comprising determining a route density for each pair of one location and one destination, and to determine a maximum route density from the determined route densities.

18. The method of claim 13, wherein the route includes a sequential list of stops, each stop being one of the locations and destinations, and wherein the method further comprises determining the route to minimize the distance between consecutive stops.

19. The method of claim 13, further comprising identifying a starting point for one of the routes, identifying the vehicle having a location closest to the starting point, and instructing the computer of the identified vehicle to actuate a component of the identified vehicle to move the identified vehicle to the starting point.

20. The method of claim 13, further comprising determining a vehicle cargo capacity and, upon determining that the number of items of cargo for one of the routes exceeds the vehicle cargo capacity, actuating a component in a second vehicle to move the second vehicle along the route.
